(19) United States
(12) Patent Application Publication
(10) Pub. No.: US 2007/0214453 A1
(43) Pub. Date: Sep. 13, 2007

(54) Installation of Software on Removable Media

(75) Inventor: Corinne Dive-Reclus, Hertfordshire (GB)

Correspondence Address: SYNNESTVEDT LECHNER & WOODBRIDGE LLP, P O BOX 592, 112 NASSAU STREET, PRINCETON, NJ, 08542-0592, US

(73) Assignee: SYMBIAN SOFTWARE LIMITED, London (GB)

(21) Appl. No.: 11/568,373

(22) PCT Filed: Apr. 29, 2005
(86) PCT No.: PCT/GB05/01652

§ 371 Date: Oct. 26, 2006

(30) Foreign Application Priority Data
Apr. 29, 2004 (GB) 0409633.5

(51) Int. Cl. G06F 9/445

(52) U.S. Cl. 717/175

(57) ABSTRACT

To install software on a computing device, a decision phase is used to decide whether or not to install the software followed by an installation phase for installing the software. Information required by the decision phase is provided in the form of metadata having an integrity protected by a digital signature and including a respective hash for files to be installed so as to enable the integrity of the file data to be verified before commencing the installation phase.

### CROSS REFERENCE TO RELATED APPLICATIONS

This application claims the priority of PCT/GB2005/001652 filed on Apr. 29, 2005, and, GB 0409633.5 filed on Apr. 29, 2004, the entire contents of which are hereby incorporated in total by reference.

The present invention relates to a method of installing software, and in particular to a method of installing software on removable media.

In the context of the present invention, the term computing device shall be construed to cover any form of electrical device and includes, data recording devices, such as digital still and movie cameras of any form factor, computers of any type or form, including hand held and personal computers, and communication devices of any form factor, including mobile phones, smart phones, communicators which combine communications, image recording and/or playback, and computing functionality within a single device, and other forms of wireless and wired information devices.

It has become common practice in computing device operating systems for software installation to be handled through specific installation packages. Originally, these packages were simple file archives which used standard archival compression formats such as .zip or .tar, but they have grown much more sophisticated over time. Among the advantages that these packages now offer are:
transparent decompression of compressed files on installation
guarantees that files are installed in correct locations in the computing device
checking of system requirements including software version and modules dependencies
authentication and verification of the integrity of the software and the identity of the software producer

Commonly used examples of systems for installing software packages include:
For Windows, Microsoft's proprietary operating system, together with third party solutions such as Wise (http://www.wise.com) and InstallShield (http://www.installshield.com); although this latter package is now multi-platform.
Various Linux distributions use package systems such as rpm (http://www.rpm.org) originally from Red Hat, and the dkpg and deb system (http://www.debian.org/doc/debian-policy/ch-binary.html) developed by Debian.
Symbian OS operating system .sis files developed by Symbian Software Limited (http://www.symbian.com/developer/techlibly70docs/SDL_v7.0/doc_source/ToolsA ndUtilities/Installing-ref/MakesisToolReference.guide.html)
Java systems use jar Java archive files (http://java.sun.com/docs/books/tutorial/post1.0/whatsnew/jar.html), while J2ME midlets additionally use jad java application description files (http://java.sun.com/j2me/docs/wtk2.1/user_html/deploy-midlets.html#wp20998)

All of the above installation packages allow for the inclusion of both files to be installed and also of the essential metadata relating to any or all of their size, target location, versioning, dependencies, certification and authentication.

The above packages integrate the software delivery mechanism and the software installation mechanism with the software authentication mechanism. Though the reasons for this are largely historical, in that package systems started off as delivery mechanisms which then integrated more functionality (firstly installation and then authentication), there are no real problems in combining these three areas of functionality in situations where computing resources are plentiful. The most typical instance of this is the provision of software packages for desktop personal computers on CD ROM, where the amount of persistent internal memory storage (such as that on hard disk) is usually not an issue, mains power is effectively inexhaustible, and the cost of the CDs themselves is negligible.

However, certain classes of computing devices are resource constrained and are generally operated in more pressured and cost-conscious resource environments. This class of devices includes personal digital assistants (PDAs) and mobile telephones using cellular wireless technology. These mobile computing devices have a more limited CPU bandwidth, generally run on battery power rather than mains power, and have relatively limited amounts of internal memory, in comparison to PC devices. Furthermore, the costs of the removable storage media used by these resource constrained devices, such as Multi Media Cards (MMC), compact flash (CF) cards and Memory Sticks, are quite unlike CD ROMs in that they are sufficiently expensive for users to limit their consumption on the grounds of cost.

For software products of any size, distribution of software using standard PC package mechanisms is regarded as unsuitable for these resource constrained devices because whatever compression and decompression mechanisms are used in the package, it is likely that there will be some point at which both compressed and uncompressed versions of the same files will need to be present on the computing device at the same time. Furthermore, these mobile devices are unlike PCs in that they lack hard disk drive storage, having only internal RAM and ‘flash’ disks available. It is not unusual to find that the removable media memory on a mobile phone has a far bigger storage capacity than the internal device memory, in which case there is clearly no point in providing software on removable media in a compressed format in the first place.

Simply providing the software pre-installed on removable media is not a good solution to this problem, because the user of the software really needs to follow an installation process in order to ensure that the software to be installed is authentic, and has not been tampered with or infected by a virus in such a way as to compromise either the security of the user's data or the operation of the device. For these mobile computing devices in particular, the security of user data is of paramount importance because the data, if acquired, could be used, in essence, to steal the user's money.

The resource constraints of these mobile devices are also problematical to alternative methods of distributing software, specifically software delivery over the internet. While fixed PCs can utilise broadband internet connections where high bandwidth with zero marginal cost makes download speeds fast and virtually free, the cellular-based internet connections used by wireless devices are at least an order of magnitude slower, are not always reliable, and are perceived by many users as being relatively expensive. Although techniques such as decompressing data ‘on the fly’ while it is being received can help to avoid some of the memory constraints mentioned above, the inconvenience and perceived cost involved with on-line software delivery renders this method impractical for software installations of any significant size.

The only current method of delivering software for resource constrained devices with wireless connections, such as PDAs and mobile phones, which does not involve the inconvenience and costs outlined above is via a PC connectivity suite. This is a class of software which runs on a non-mobile PC but which is normally provided with the mobile device and allows software to be installed safely cheaply and conveniently on the device while it is connected to the PC. There are however numerous disadvantages for this method of software delivery. The most obvious of these are
The owner of the mobile device requires access to a compatible PC, which is not necessarily the case.
Owners of PCs can find that the connectivity software provided with a mobile device is not compatible with their personal computer.
Software cannot be installed while the mobile device is actually mobile, but requires a fixed location.

Thus, there is currently no satisfactory method of installing software on resource constrained mobile devices which combines the requirements of convenience, efficiency, reliability, speed and security.

It is therefore an object of the present invention to provide an improved method for installing software onto a computing device.

According to a first aspect of the present invention there is provided a method of installing software on a computing device, the method comprising a decision phase for deciding whether or not to install the software and an installation phase for installing the software, and in which information required by the decision phase comprises metadata having an integrity protected by digital signature and including a respective hash for files to be installed for verifying the integrity of the file data.

According to a second aspect of the present invention there is a provided a computing device arranged to operate in accordance with a method of the first aspect.

According to a third aspect of the present invention there is provided a computer software package for installing software on a computing device for causing the computing device to operate in accordance with a method according to the first aspect.

An embodiment of the present invention will now be described, by way of further example only, with reference to the accompanying drawings, in which:—

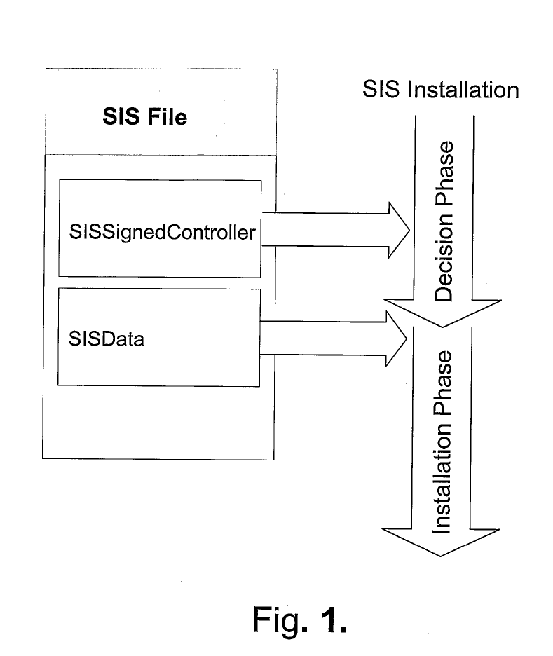

FIG. 1 illustrates schematically a software installation process in which the installation process and the installation file have each been split into two independent phases;

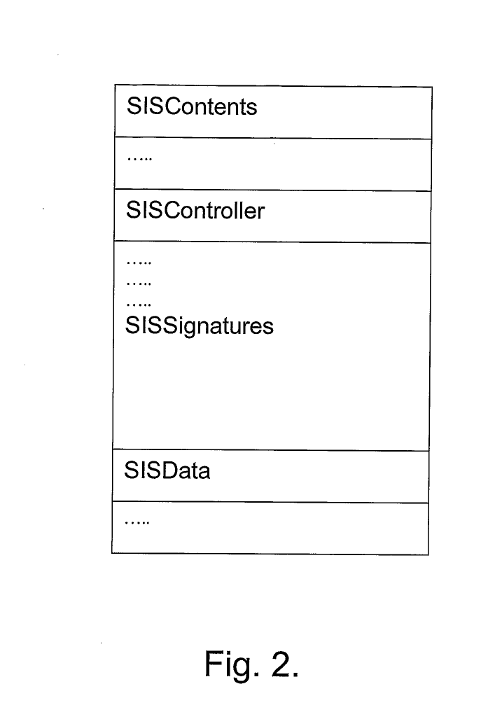

FIG. 2 illustrates schematically a software installation file format in which new signature and certificate chains have been inserted at the end of metadata information in the file;

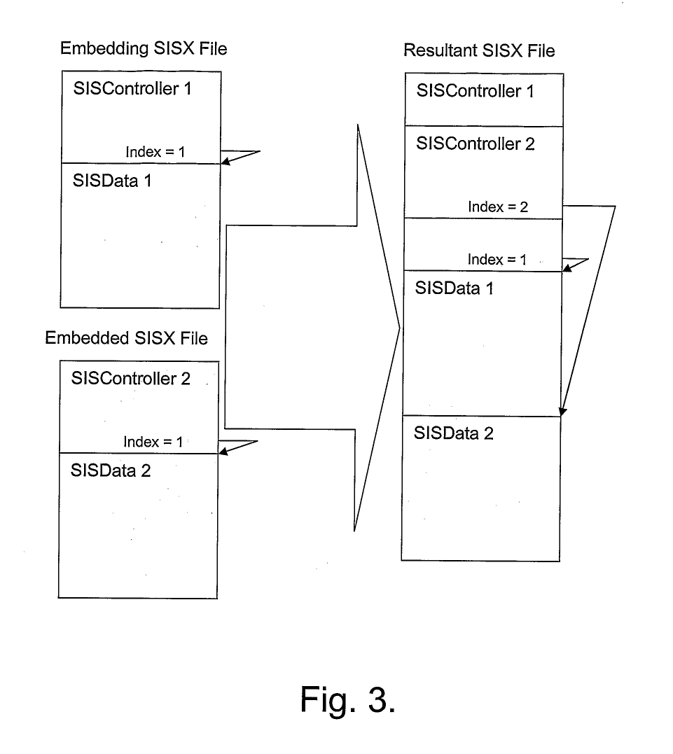

FIG. 3 illustrates schematically a method of inserting one software installation file into another;

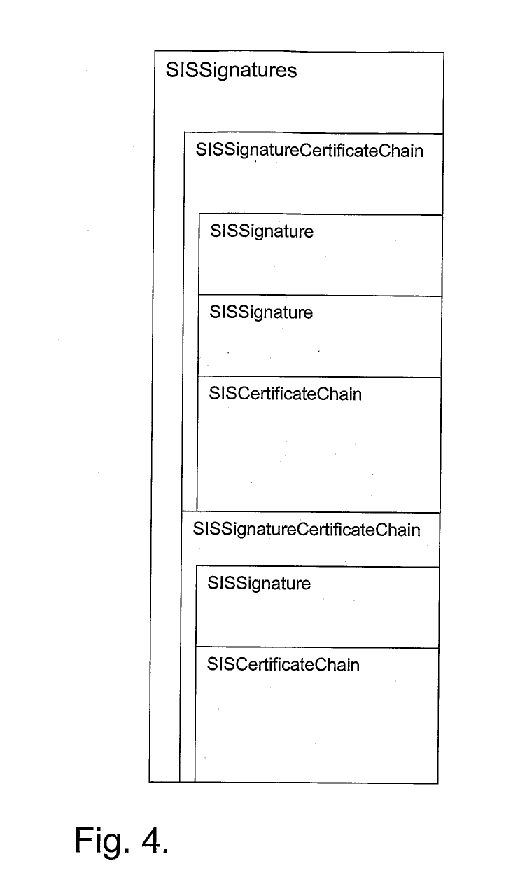

FIG. 4 illustrates schematically a software installation file format designed to support signing using multiple certificate chains, with multiple signatures supported for each chain; and

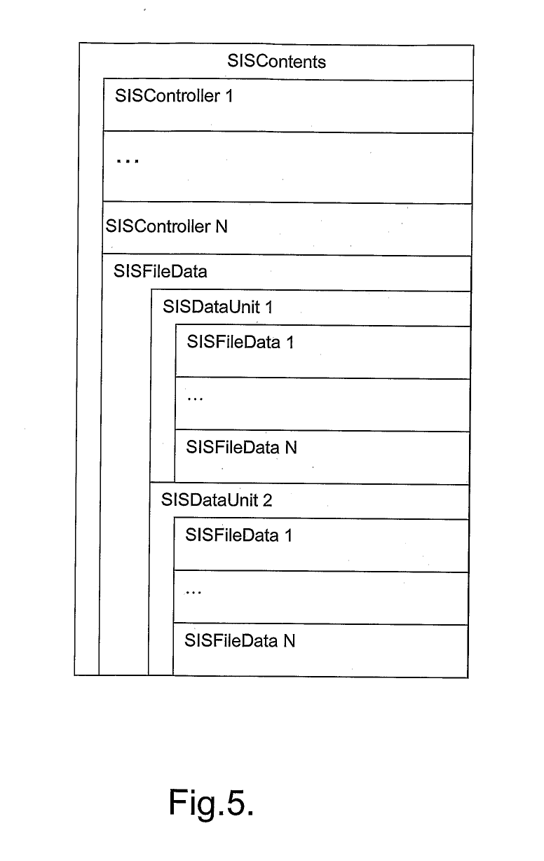

FIG. 5 illustrates schematically a software installation file having one data file embedded in another.

This invention is predicated on the perception that when software is delivered on removable media for use with wireless devices, it makes more sense to provide software uncompressed and with files already placed in the correct location, together with a package system capable of providing the functionality for ensuring secure operation of the software. Specifically, with the present invention it is possible to check both system requirements and dependencies, and also to authenticate and verify the integrity of the software and the identity of the software developer, without having to decompress and install all the files contained in the package.

A preferred embodiment of the present invention is described below with reference to SIS files for the Symbian OS™ operating system available from Symbian Software Limited of London, England, which includes a software install package. However, it is stressed that the method of the present invention can be used to equal advantage with other forms of software install packages, whether these are stand alone type packages or incorporated into other types of operating systems.

Symbian SIS files of the Symbian OS™ operating system have historically been used to package any number or type of files for installation on a mobile computing device running this operating system. This operating system is provided with a utility software program known as ‘makesis’, which is responsible for the generation of SIS files, a separate software install program (referred to herein as software install) being used to perform the actual software installation. In the example described below the format of these SIS files and the installation procedure have been modified in order to implement the invention. This new format is referred to in the example below as SISX (extended SIS).

With the present invention, the installation process and the installation file have each been split into two independent phases. The installation process phases are referred to as the Decision Phase and the Installation Phase. To support each phase, the SISX file is provided as two parts: a SISSignedController part and a SISData part, as shown in FIG. 1.

The SISSignedController is the only part needed to complete the Decision Phase. This is a relatively small part of the SISX file (typically <10 kb) so that it can be read entirely in memory. This part contains metadata needed to install the required software files on the computing device, such as authentication, capability; and so on. However, with the present invention, the metadata is arranged also to contain a respective hash for each file in the SISData part, and must be digitally signed using a standard certificate, such as a certificate conforming to the X.509 v.3 public key infrastructure, which is verifiable either at install time or at run time.

The SISData part contains all the data that is not required in the Decision Phase. This mainly consists of the actual files to be installed on the computing device, together a very limited amount of control information.

There are two very significant key commercial advantages of this format:
a) When installing files onto a mobile smart phone ‘over the air’, the relatively small SISSignedController part can be downloaded first and the decision phase can, therefore, proceed almost immediately. Should any failures occur during this phase, the user is saved the significantly extra time and expense associated with downloading the entire installation file because the relatively time consuming and therefore more costly installation phase only proceeds after the decision phase has been completed successfully.
b) For data that comes on MMC cards and does not need to be installed, only the SISSignedController part need be provided on the card with the pre-installed software, enabling standard authentication and other security measures to proceed as normal even though the normal installation process is unnecessary.

The first of these advantages is shared by the Java package system, in which JAD files contain the metadata for the decision phase of an installation and JAR files contain the remainder of the package data. In common with the SISX files of the present invention, software delivered using the Java JAD/JAR package system needs to download only the JAD file to know whether or not the software can safely be installed. However, in strict contrast to the present invention, with the Java system, the hashes which are needed to ensure the integrity of the software files to be installed are included with the content in the JAR file. Therefore, unlike the present invention, it is not possible with the Java JAD/JAR package system to ensure the authenticity of software for installation which is provided on removable media by providing a JAD file with pre-installed software.

The SISX file format will now be described with reference to a device running the Symbian OS™ operating system. It will of course be readily apparent to one skilled in the art that many other implementations are possible, and it will also be apparent which parts of the description are not essential to the implementation of the invention. For example, the SISX file format in the embodiment described specifies that all metadata should be stored in little-endian format, but this is done for convenience and there is no reason why either a big-endian or an agnostic-endian implementation of the invention may be provided. Similarly, the fact that the SISX format specifies CRC-32 checks for verifying integrity does not exclude other methods of achieving the same result.

The information in the SISX file is split into two separate parts. The first part is the metadata, describing the files that need to be installed. The second part of the SISX file contains all the actual file data. This enables software installation to be split into the decision and installation phases referred to above. During the decision phase, the SISX file is examined and security checks are carried out in order to verify the install. The installation phase is only carried out if the verification is successful and is the process of actually copying the required files to the device.

The SISX file format supports signatures and certificates to enable a package to be signed. These signatures are verified during installation, and can also be re-verified after the package is installed on the device. In order to support the processing of the SISX file in two phases, only the metadata of the SISX file is signed. However, with the present invention, the metadata also contains a respective hash for each file in the package for installation, in order to ensure the integrity of the data in each such file. In this manner, the integrity of the entire SISX file is protected by the signed metadata. This means that during the installation phase, the software install process can verify for each file being installed, the respective hash for each file against the ‘protected’ hash included in the signed metadata, whilst using an untrusted component to perform installation decompression.

Separate checksums for each of the metadata and the file data may also be present in the SISX file to enable any possible corrupt SISX files to be detected at the beginning of the installation process.

Due to the effort involved in changing file formats, the SISX format is designed to be extensible, and uses a type-length-value format. Each field in the SISX file (SISField) has a specified length. Thus, when reading a SISX file the fields whose types are unknown can be skipped.

In common with other types of installation packages, the compression scheme used in the SIS file format of the Symbian OS™ operating system is to compress the whole SIS file, and at install time decompress to a separate file and install from that decompressed file. This can be wasteful, especially in the case where large files can be installed as an option, since there needs to be space left in the memory in the device in order to decompress the whole of the original SIS package, including the optional files. The SISX file format of the present invention supports the separate compression of each of the files in the SISX file, and the SISController can also be compressed. This reduces the memory space needed to carry out file installation. Compression is supported by using a SISCompressed SISField which can contain another integral compressed SISField.

In this embodiment of the present invention the SISX file format is designed to support almost all of the original features of the SIS file format. The only limitation imposed is that there should be no more than 8 levels of embedded SISX files. It is to be understood that this is not a limitation of the SISX file format itself but is one which has been imposed to limit the overall complexity of the install process.

Since the SISX file format has no offsets which need to be changed it is easy to add a new signature and certificate chains to the end of the metadata of the SISX file, even though they may be located in the middle portion of the file, as illustrated in FIG. 2. In this case the SISSignatures SISField will be lengthened by the new signature and certificate chains, and the SISFields following these additions will be moved to a position later in the file.

The SISX file format is designed so that each type of SISField may be represented by one C++ class. This makes it easy to construct a C++ class instance from a SISField, and since there are no offsets used in the file format, it is possible to construct a C++ class with just the data from the SISField.

Because a SISX file may be large in size it may not possible to load the entire file contents into memory at once. Due to the structure of the file format, the metadata information of each SISField can be read without reading all of the data in the contained SISFields.

There are various operations which need to obtain a flat view of the SISX file format data; for instance carrying out the CRC checking, and verifying the signature of the metadata. Therefore, the format is preferably designed so that all data in each SISField are stored consecutively.

The SISX format also supports the embedding of one SISX file into another. A MakeSIS tool is provided which is able to take an already generated SISX file and embed it into a SISX file that it is creating. The existing SISX file is loaded, and the SISController decompressed if necessary and inserted into the embedded SISX files field of a SISInstallBlock within the file. A SISDataUnit, which contains the files needed for installation, is added onto the end of the Data Units array of a SISData SISField. The SISControllers have a Data Index field, which indicates the index of the SISDataUnit which contains the files they need. Hence, the MakeSIS tool is required to iterate through the added SISControllers and change these to the correct index values. This process for embedding one or more SISX files into another is illustrated in FIG. 3.

All metadata are stored in little-endian byte ordering format. Furthermore, to simplify the upgrade from SIS to SISX file format, the latter is arranged to support only one text character set, such as Unicode UCS-2 encoded strings.

In this embodiment of the invention, the number of levels of embedding of SISX files is limited to eight, although it is to be understood that this is not a limitation of the file format, but a limitation imposed on software install in order to restrict the possible complexity of an installation.

An overview of an exemplary SISX file structure will now be provided.

The SISX file format is composed of SISFields encoded using a Type-Length-Value (TLV) format. All SISFields are stored in this format, with the exception of any SISField which is stored inside a SISArray. This is because an array stores SISFields of the same type, and hence it is unnecessary and inefficient to store the Type value for each entry in the array. Thus, only the Lengths and Values of SISfields are stored in a SISArray.

The Type field indicates the type of the SISField. Each type of SISField has a unique identity (ID), and is 4 bytes in length.

The Length field indicates the length of the data in the Value field, and does not include the sizes of the other fields contained in the SISField. The Length field is either 4 or 8 bytes in length, depending on the Length value to be stored. This is because for some fields it is necessary to support a 64 bit length, but for most fields a shorter bit length only is required. Hence, storing the length in 64 bits for all fields would use unnecessary memory space in the device.

The Length is always represented by an unsigned value. If the Length value is smaller than 2³¹ then the value is stored using 32 bits (4 bytes). If the Length value is greater than or equal to 2³¹ then the value is stored using 64 bits (8 bytes). The most significant bit is set to one, meaning the greatest possible data length which can be represented is 2⁶³−1. To read in the Length value the first 32 bits are firstly read in. If the most significant bit is zero, then the lower 31 bits represent the value. If the most significant bit is one, then the next 32 bits are read in and the 63 bit value is constructed from both parts. The Value field contains the data of the SISField. Its format depends on the field ID. This format dependency is used because it makes it very easy to construct a C++ class instance from a SISField. It is also possible to construct this instance by using only the data in the SISField and no other part of the SISX file.

The SISX file is also preferably padded where necessary so that each SISField begins on a 32 bit word boundary. This is to enable efficient parsing of the format from memory with processors which only allow 32-bit aligned access.

The following notation is used to describe the data-structures used by the SISX file format:

| Structure Name | | |
|---|---|---|
| Name of Field 1 | Type of Field | Size of Field |
| . . . | . . . | . . . |
| Name of Field N | Type of Field | Size of field |

The Structure name is the name of the structure, which determines the ID stored in the type field. The length is determined by the length of all the fields specified. The fields 1 to N, specify the data which should appear in the value part of the structure.

The SISX file contains fields which can be categorized as ‘General SISFields’ and ‘MetaData SISFields’. The content of these two field categorisations will now be explained.

General SISFields

SISString

This SISField contains a UCS-2 encoded Unicode string.

| SISString | Length |
|---|---|
| String | |

String

This field contains the Unicode UCS-2 encoded string. Its length in bytes is specified by the Length field, and since each character is encoded using 16 bits there are one half as many characters in the string, as this length.

SISArray

The SISArray SISField holds an array of one SISField type. The type of the contained SISFields is checked on creation from data, and addition of each new SISField. The notation SISArray<SISString> is used to indicate an array of SISStrings. All of the SISFields in the array are stored without their type as an optimisation, so just the length and value parts of the TLV format are stored.

| SISArray | Length | |
|---|---|---|
| SISField Type | TUint32 | 4 bytes |
| SISField 1 | SISField | |
| ... | ... | |
| SISField N | SISField | |

SISField Type

This field indicates the type of the SISFields in the array. All of the fields are of the same type and this is checked on creation of the SISField from data, and addition of each new SISField.

SISFields

This is a sequence of SISFields, whose type is equal to the value of the SISField type field. The SISField is only partially stored, the type being omitted as an optimisation since it can be determined from the SISField Type field of the SISArray. The number of fields can be determined by reading in all the fields until all the data specified by the Length of the SISArray SISField has been read. In several places in the SISX file format an array of SISFields is needed, so in order to reduce code duplication a SISArray type is also provided.

SISCompressed

This SISField is a wrapper around another SISField, where the wrapped SISField can be optionally compressed. This allows easy integration of compression into the SISX file format. The notation SISCompressed<SISString> may be used to indicate a compressed SISString.

| SISCompressed | Length | |
|---|---|---|
| Compression Algorithm | TUint8 | 1 byte |
| Compressed Data | | Compressed Data |
| Length bytes | | |

Compression Algorithm

This SISfield contains the algorithm used to compress the data for this file.

enum TCompressionAlgorithm

| | |
|---|---|
| { | |
| ECompressNone = 0, | //The data is uncompressed |
| ECompressDeflate | //The data is compressed according to RFC 1951 |
| }; | |

Compressed Data

This SISfield contains compressed data. The length can be determined from the Length field.

SISVersion

This SISField provides a data structure for the storage of a version number, with major minor and build components.

| SISVersion | Length | |
|---|---|---|
| Major | TInt32 | 4 bytes Minor |
| | TInt32 | 4 bytes |
| Build | TInt32 | 4 bytes |

Only positive values or zero are used to indicate a specific version. However, where applicable, the major, minor, or build components of the SISVersion can be set to −1 in order to indicate any version.

SISVersion Range

This SISField specifies a range of versions. It is used to indicate which versions can satisfy a certain dependency. If the range is only a specific version then both the ‘From Version’ and ‘To Version’ fields provided should be set to the same specific value. If an upgrade specified is applicable to any version, then both the ‘From version’ and the ‘To Version’ fields should have the major, minor and build components set to −1.

| SISVersionRange | Length |
|---|---|
| From Version | SISVersion |
| To Version | SISVersion |

When checking a dependency, the installed version of the package is checked against the ‘From Version’ and the ‘To Version’ fields separately. To check the ‘From Version’ field, firstly the major version of the package being installed is checked against the major version of the already installed version. If the installed major version is less, then this dependency check fails. If the installed major version is greater, than this dependency check passes. If the two versions are equal, then the minor version is checked in the same way. If all the components of the major and minor versions are equal then the dependency check passes. In this way a lexicographical comparison of the versions is carried out. The value of −1 in any of the major, minor or build versions is treated as a special case. If the situation arises where a comparison is with a field where the ‘From Version’ is −1, then the dependency check passes. The ‘To Version’ is checked in a similar way.

The following examples show typical comparison check results:

| | Major | Minor | Build |
|---|---|---|---|
| From Version | 3 | −1 | −1 |
| To version | 4 | 5 | −1 |

This check result will upgrade any version from 3.x.x to 4.5.x, where x is any value.

| | Major | Minor | Build |
|---|---|---|---|
| From Version | 1 | 3 | 4 |
| To version | 1 | 3 | 5 |

This check result will upgrade either version 1.3.4 or 1.3.5.

SISDate

This SISField contains a date. The date is stored according to the Gregorian calendar with the year part being stored in full, and must be a valid date.

| SISDate | Length | |
|---|---|---|
| Year | TUint16 | 2 bytes |
| Month | TUint8 | 1 byte |
| Day | TUint8 | 1 byte |

SISTime

This SISField contains a time. The time must be expressed in UTC, and be a valid time.

| SISTime | Length | |
|---|---|---|
| Hours | TUint8 | 1 byte |
| Minutes | TUint8 | 1 byte |
| Seconds | TUint8 | 1 byte |

SISDateTime

This SISField contains both date and time SISFields.

| SISDateTime | Length |
|---|---|
| Date | SISDate |
| Time | SISTime |

SISUidx

This SISField contains three unique identities (UIDs).

| SISUid | Length | |
|---|---|---|
| UID 1 | TInt32 | 4 bytes |
| UID 2 | TInt32 | 4 bytes |
| UID 3 | TInt32 | 4 bytes |

SISVendorID

This SISField contains a Vendor ID. This ID is unique to a certain vendor.

SISVendorID

| SISVendorID | Length | |
|---|---|---|
| Vendor ID | TInt32 | 4 bytes |

VendorID

This SISField indicates the vendor. Each vendor has its own unique ID.

SISLanguage

This SISField identifies a language.

| SISLanguage | Length | |
|---|---|---|
| Language | TUint32 | 4 bytes |

Language

The value of this field corresponds to the TLanguage enumeration, but is stored as a TUint32 in the SISX file.

SISX File Metadata SISFields

SISContents

This SISField contains the whole of the contents of the SISX file. The contents are split up into the SISController, which contains the metadata, and the SISData, which contains the actual file data.

| SISContents | Length |
|---|---|
| Controller Checksum | SISControllerChecksum |
| Data Checksum | SISDataChecksum |
| Controller | SISCompressed <SISController> |
| Data | SISData |

Controller Checksum

This checksum is a CRC-32 checksum over the contents of the Controller field. The checksum covers the whole of the SISCompressed<SISController>, so if the SISController is compressed, it does not have to be decompressed to verify this checksum. Thus, the integrity of the controller may be checked without checking the whole file.

Data Checksum

This checksum is a CRC-32 checksum over the contents of the Data field. This enables the checking of the integrity of the data without checking the whole file.

Controller

The controller contains all the metadata for the SISX file. This can be optionally compressed.

Data

The data field contains the actual files in the SISX file. These are processed differently depending on the metadata present in the controller field.

SISControllerChecksum

This SISField contains the checksum for the possibly compressed SISController.

| SISControllerChecksum | Length |
|---|---|
| Checksum | TUint32 |

Checksum

This field contains the CRC-32 checksum, which is calculated over the whole of the SISCompressed<SISController> SISField. PS SISDataChecksum

This SISField contains the checksum for the SISData section of the SISX File.

| SISDataChecksum | Length |
|---|---|
| Checksum | TUint32 |

Checksum

This field contains the CRC-32 checksum, which is calculated over the whole of the SISData SISField.

SISController

This SISField contains the metadata for the SISX file.

| SISController | Length | |
|---|---|---|
| Info | SISInfo | |
| Options | SISSupportedOptions | |
| Languages | SISSupportedLanguages | |
| Prerequisites | SISPrerequisites | |
| Properties | SISProperties | |
| Logo | SISLogo | |
| Install Block | SISInstallBlock | |
| Signatures | SISSignatures | |
| Data Index | TUInt16 | 2 bytes |

The metadata content for the SISX file is as follows

Info

This field contains information about the SISX file.

Options

This field contains the options that the user is asked to choose from when installing the file. These options are used to determine which files to install.

Languages

This field contains the languages supported by the SISX file.

Prerequisites

This field contains the prerequisites needed in order to install the SISX file.

Properties

This field contains properties, which are key, value pairs of integers.

Logo

This field is optional, and if present contains a logo which is displayed at the start of installation.

Signatures

This field contains the signatures that have signed the SISX file as well as the certificate chains needed to verify them.

Data Index

This field is an index into the array of Data Units field of the SISDataSISField. There is one SISDataUniffor each SISController.

SISInfo

This SISField contains the following information about the SISX file.

| SISInfo | Length | |
|---|---|---|
| UID | SISUid | |
| Vendor ID | SISVendorID | |
| Names | SISArray<SISString> | |
| Vendor Names | SISArray<SISString> | |
| Version | SISVersion | |
| Creation Time | SISDateTime | |
| Install Type | TUint8 | 1 byte |

UID

This field contains the UID of the SISX file. The UID should be unique to a SISX file packaging a certain application, but there may be multiple different versions of this package, with the same UID.

Vendor ID

This field contains the ID of the vendor which created the package.

Names

This field contains an array of names of the SISX file. There is one name for each of the languages supported, and each name is matched to the corresponding language identified in the SISSupportedLanguages field of the SISController, at the same position in that array.

Vendor Names

This field contains an array of names of the SISX file vendor. There is one name for each of the languages supported, and each name is matched to the corresponding language identified in the SISSupportedLanguages field of the SISController, at the same position in that array.

Version

This field contains the version of the SISX file.

Creation Time

This field contains the creation time and date of the SISX file. However, this is not a secure timestamp and therefore can easily be altered by a user changing their PC clock before creating the SISX file.

Install Type

This field contains the type of installation of the SISX file. Depending on the value, the installation software will install the package using different behaviour. The value is stored as a TUint8 but corresponds to the following enumeration:

enum TInstallType

{
EInstApplication
};

EInstApplication

The SISX file contains an application that can be installed on the device. Once it has been installed, it appears in the list of installed SISX files so that the user can remove it. If the user wants to install a SISX Installation File that has the same UID and type EInstApplication on a device where there is already a SISX file installed with that UID and type EInstApplication, then this is considered as an upgrade. If this occurs, the current version is removed from the device and the new version is installed.

SISSupportedLanguages

This SISField contains an array of languages that the SISX file supports.

| SISSupportedLanguages | Length |
|---|---|
| Languages | SISArray<SISLanguage> |

SISSupportedOptions

This SISField contains options that the SISX file supports. The user is asked to select from these options during install.

| SISSupportedOptions | Length |
|---|---|
| Options | SISArray <SISSupportedOption> |

Options

This field is an array of options supported by the SISX file. There is one entry in the array for each option supported by the SISX file, and its size may be zero or greater.

SISSupportedOption

This SISField contains names for a supported option of the SISX file. There is a name in the array for each supported language in the SISX file, in the same order as specified in the SISSupportedLanguages SISField.

| SISSupportedOption | Length |
|---|---|
| Names | SISArray <SISString> |

SISPrerequisites

This SISField indicates the prerequisites that have to be met before the installation software will install the SISX file. The supported types of prerequisites in this embodiment are:
i. SISX packages already installed on the device, and their version.

ii. The device must be one of a list of devices, identified by SISX files pre-installed on the device.

| SISPrerequisites | Length |
|---|---|
| Target Devices | SISArray <SISDependency> |
| Dependencies | SISArray < SISDependency > |

Target Devices

This field is an array of SISDependency SISFields indicating on which devices this SISX file can be installed. Each device has a SISX file pre-installed, specific to that device. If the Target Devices SISArray contains any SISDependencies then at least one of these dependencies must be present in order to install the SISX file on the device. If the Target Device SISArray has no entries then the SISX file can be installed on any type of device.

Dependencies

This field is an array of SISDependencies indicating which SISX packages need to be installed in order for this one to be installable. There may be zero or more dependencies. For installation to continue, all the SISX files present in this SISArray must exist on the device.

SISDependancy

This SISField specifies a SISX package that must be installed on the device.

| SISDependency | Length |
|---|---|
| UID | SISUid |
| Version Range | SISVersionRange |
| Dependency Names | SISArray<SISString> |

UID

This field indicates the UID of the SISX package which needs to be installed on the device, in order to satisfy this dependency.

Version Range

This field indicates the range of versions of the SISX package that needs to be installed on the device.

Dependency Names

This array contains the list of names of the dependency in each of the languages supported by the SISX file. There must be exactly one SISString per language supported by the SISX file.

SISProperties

The SISProperties block contains properties for the SISX package.

| SISProperties | Length |
|---|---|
| Properties | SISArray<SISProperty> |

SISProperty

This SISField contains a property, which is a key, value pair associated with a SISX package.

| SISProperty | Length | |
|---|---|---|
| Key | TInt32 | 4 bytes |
| Value | TInt32 | 4 bytes |

SISLogo

This SISField may contain a logo that is displayed during the installation process.

| SISLogo | Length |
|---|---|
| Logo File | SISFileDescription |

Logo File

This field contains the SISFileDescription for a logo file which is displayed at the start of installation. The MIME type field of the SISFileDescription is used to determine what format the logo is in. If the target field of the SISFileDescription is not an empty string, then the logo is also installed on the device.

SISFileDescription

This SISField gives information about a file stored in the SISData section.

| SISFileDescription | Length | |
|---|---|---|
| Target | SISString | |
| MIME Type | SISString | |
| Operation | TUint8 | 1 byte |
| Operation Options | TUint32 | 4 bytes |
| Hash | SISHash | |
| Length | TUint64 | 8 bytes |
| Uncompressed Length | TUint64 | 8 bytes |
| File Index | TUint32 | 4 bytes |

Target

This field is the location to install the file to. This is only used for the instructions that are actually going to copy the file somewhere on the device; it may be an empty string indicating the file will not be installed, for example when it is required to run a file, or display it as a logo, without actually installing it on the device.

MIME Type

This field is the MIME type of the file described. This is used when running a file by MIME type and also when displaying an image file during install in order to choose the type of image decoder to use.

Operation

This field is used to indicate how to process this file during installation.

enum TSISFileOperation

| { | | |
|---|---|---|
| EOpInstall | = 1, | // Install File |
| EOpRun | = 2, | // Run File |
| EOpText | = 4 | // Display File as Text |

};

Operation Options

This field indicates which options are applicable to the processing of this file during installation. The operation being carried out determines which options are valid.

Options Valid for EOpInstall

enum TInstallOption

| { | | |
|---|---|---|
| EInstVerifyOnRestore | = 1<<15 | // Verify on Restore |

};

EInstOptionReadOnly

This option is used for secure backup and restore, to indicate that this file has been written to after install, and so its contents will remain the same as when it was installed. This allows verification, by checking the hash, upon restoration of the file from a backup.

Options Valid for EOpRun

enum TInstFileRunOption
{

| | | |
|---|---|---|
| EInstFileRunOptionInstall | = 1<<1, | // Run at installation |
| EInstFileRunOptionUninstall | = 1<<2, | // Run at uninstallation |
| EInstFileRunOptionByMimeType | = 1<<3, | // Run using MIME type |
| EInstFileRunOptionWaitEnd | = 1<<4, | // Wait for end before |
| | | continuing |

};

EInstFileRunOptionInstall

This option indicates that the file specified will be run at installation time. If the target field is valid, then this file is installed to that location, otherwise this file is not copied to the device.

EInstFileRunOptionUninstall

This option indicates that the file specified will be run at uninstallation time. The target field must be valid, because the installation software will copy this file to the device so that it can be run at the time when the package is uninstalled.

EInstFileRunOptionByMimeType

This option indicates that the file is to be run, either at installation or uninstallation time, by MIME type. If this option is not set then the file specified will be run as an executable.

EInstFileRunOptionWaitEnd

If this option is set, the installation software waits until the application being run finishes before continuing. However, the installation software should implement a sensible timeout; otherwise a malicious or malformed application could run forever and prevent any other access to the installation software without rebooting the device. If this option is not set, the installation software does not wait for the application being run to finish before continuing. Once the installation software has finished this installation or uninstallation, the applications which are still running are terminated.

Options Valid for EOp Text

enum TInstTextOption

| { | | |
|---|---|---|
| EInstFileTextOptionContinue | = 1<<9, | // Continue button |
| EInstFileTextOptionSkipIfNo | = 1<<10, | // Yes/No - skip next |

file if user

selects no

| | | |
|---|---|---|
| EInstFileTextOptionAbortIfNo | = 1<<11, | // Yes/No - abort |

install if user

selects no

| | | |
|---|---|---|
| EInstFileTextOptionExitIfNo | = 1<<12, | // Yes/No - uninstall |

if user selects no

};

EInstFileTextOptionContinue

This option indicates that the installer should display the text, with a button to continue the install. After the dialog has been dismissed the installation will continue.

EInstFileTextOptionSkipIfNo

This option indicates that the installer should display the text, with two buttons, one labeled ‘yes’ and one labeled ‘no’. If the ‘no’ button is selected then the installer shall skip the file currently being processed, otherwise installation will continue as normal.

EInstFileTextOptionAbortIfNo

This option indicates that the installer should display the text, with two buttons, one labeled ‘yes’ and one labeled ‘no’. If the ‘no’ button is selected then the installer shall abort the installation, otherwise installation will continue as normal. The installer will display a dialog indicating that the installation has been aborted.

EInstFileTextOptionExitIfNo

This option indicates that the installer should display the text, with two buttons, one labeled ‘yes’ and one labeled ‘no’. If the ‘no’ button is selected then the installer shall abort the installation, otherwise installation will continue as normal. The only difference between this option and the EInstFileTextOptionAbortIfNo option is that the installer will not display a dialog indicating that the installation has been aborted.

Hash

This field contains the hash of the uncompressed file data.

Length

This field contains the length of the compressed file data the SISFileDescription is referring to in the SISX file itself.

Uncompressed Length

This field contains the length of the compressed file data the SISFileDescription is referring to after it has been decompressed.

File Index

This field is an index of the SISFileDataSISField, which contains the actual file data, in the Data Units field of the SISDataUnit.

SISHash

This SISField represents a hash.

| SISHash | Length | |
|---|---|---|
| Hash Algorithm | TUint8 | 1 byte |
| Hash Data | | |

Hash Algorithm

This field indicates the algorithm used to generate the hash. Typical hash algorithms that may be supported are:

enum TSISHashAlgorithm
{

| | |
|---|---|
| ESISHashAlgSHA1 = 1, | // SHA-1 hash algorithm |

}

Hash Data

This field contains the raw data of the hash. The length of data depends upon the hashing algorithm used.

The SSIX file format has been designed to support signing using multiple certificate chains. Multiple signatures are also supported for each chain, enabling different algorithms to be used for each of the signatures. The chain layout is shown in FIG. 4. Only one of these signatures needs to be validated for the installation software to consider the Certificate Chain as valid.

SISSIgnatures

This SISField contains multiple signatures and certificate chains needed to validate these signatures.

| SISSignatures | Length |
|---|---|
| | SignaturesSISArray<SISSignatureCertificateChain |

SISSignatureCertificateChain

This SISField contains the signatures used to sign the SISX file and the certificate chain needed to validate the signatures.

| SISSignatureCertificateChain | Length |
|---|---|
| Signatures | SISArray<SISSignature> |
| Certificate Chain | SISCertificateChain |

Signatures

This field contains an array of signatures.

Certificate Chain

This field contains the certificate chain needed to verify the signatures.

SISCertificateChain

This SISField contains the certificate data as an ASN.1 encoded X509 certificate chain.

| SISCertificateChain | Length |
|---|---|
| Certificate Data | |

Certificate Chain

This field contains the certificate data as an ASN.1 encoded X509 certificate chain.

SISSignature

This SISField contains the signature and an identifier of the signing and hashing algorithms used to generate it.

| | |
|---|---|
| SISSignature | Length |

Signature Algorithm
Signature Data

Signature Algorithm

This contains the algorithm used for signing, and the algorithm used for hashing the data, to enable the signature to be validated.

Signature Data

This field contains the signature data.

SISSignatureAlgorithm

This SISField contains details about the signature and hash algorithms used to create a signature.

| SISSignatureAlgorithm | Length |
|---|---|
| Algorithm Identifier | SISString |

Algorithm

This is a string delimited by ‘.’ characters which represents the Object Identifier of the algorithms used. Typical algorithms are:
1. “1.2.840.113549.1.1.5”—SHA-1 with RSA signature
2. “1.2.840.10040.4.3”—SHA-1 with DSA signature

The SISX file is generated from a textual package description. This description supports a simple format of deciding which files to install, at installation time, using ‘if’, ‘then’, and ‘else’ constructs. This is encoded into the SISX package using the following SISFields.

This SISField represents an ‘if’ statement and condition in the package file used to generate the SISX file.

| SISIf | Length |
|---|---|
| Expression | SISExpression |
| Install Block | SISInstallBlock |
| Else ifs | SISArray<SISEIself> |

Expression

This field contains the expression which is evaluated during the processing of this SISField during install.

Install Block

This field contains the SISInstallBlock that is processed recursively if the expression evaluates to true.

Else ifs

If the expression evaluates to false then each of these SISEIself SISFields are evaluated in sequence. If one of the expressions evaluates to true then the SISInstallBlock is processed recursively and no further SISEIself blocks in the array are checked. There may be zero or greater SISEIself SISFields in this array. MakeSIS can simulate an else statement in the package, by adding a SISEIself SISField, with a condition which always evaluates to true.

SISEIself

This SISField represents the ‘else if’ part of an ‘if’ statement in the package file.

| SISEIself | Length |
|---|---|
| Expression | SISExpression |
| Install Block | SISInstallBlock |

Expression

This field is evaluated by the installation software while processing the SISEIself SISField.

Install Block

If the Expression field evaluates to true, then this SISInstallBlock SISField is processed recursively by the installation software.

SISInstallBlock

This SISField contains a list of files which need to be installed, a list of embedded SISX files, and a list of SISif blocks inside this install block. Each of these arrays may have zero or more entries.

| SISInstallBlock | Length |
|---|---|
| Files | SISArray<SISFileDescription> |
| Embedded SISX Files | SISArray<SISController> |
| If Blocks | SISArray<SISIf> |

Files

This field contains a list of files, which need to be processed with the SISInstallBlock. The most common operation to perform will be to install these files, but depending on the options they may be displayed to the user or run. There may be zero or greater SISFileDescription SISFields in this array.

Embedded SISX Files

This field contains a list of embedded SISX files, which are represented by SISControllers stored in the metadata of the SISX file and need to be processed with the SISInstallBlock. There may be zero or greater SISController SISFields in this array.

If Blocks

This field contains a list of SISIf fields, which need to be processed with the SISInstallBlock. The installation software will check the condition of each of these SISIf blocks and if it is true, process that SISIf block recursively. There may be zero or greater SISIf SISFields in this array.

SISExpression

This SISField represents an expression. Expressions are broken down into parts, and the whole expression is represented as a tree of SISExpression SISFields.

| SISExpression | Length | |
|---|---|---|
| Operator | TInt16 | 2 bytes |
| Left Expression | SISExpression | |
| Right Expression | SISExpression | |
| Integer Value | TInt32 | 2 bytes |
| String Value | SISString | |

If the operator is EOpNone then the SISField will contain no other data, and be of the form:

| SISExpression | Length |
|---|---|
| Operator | TInt16 = EOpNone |

This is to allow the termination of the expression.

Operator

This field indicates the operator for this expression and thus determines which of the other fields are valid.

enum TOperator

{
EOpNone = 0,
// Binary Operators

| | |
|---|---|
| EBinOpEqual = 1, | // equal to |
| EBinOpNotEqual, | // not equal to |
| EBinOpGreaterThan, | // greater than |
| EBinOpLessThan, | // less than |
| EBinOpGreaterOrEqual, | // greater than or equal to |
| EBinOpLessOrEqual, | // less than or equal to |

// Logical Operators

| | |
|---|---|
| ELogOpAnd, | // logical AND |
| ELogOpOr, | // logical OR |

// Unary Operators

| | |
|---|---|
| EUnaryOpNot, | // NOT( ) - logical NOT |

// Functions

| | |
|---|---|
| EFuncExists, | // EXISTS( ) - Checks if the file exists |
| EFuncAppProperties, | // APPPROP( )-Queries application properties |

// Primitives

| | |
|---|---|
| EPrimTypeString, | // This expression holds a string value |
| EPrimTypeOption, | // This expression is an option, identified |
| | by string |
| EPrimTypeVariable, | // This expression is a variable, identified |
| | by string |
| EPrimTypeNumber | // This expression holds a number value |

};

Left Expression

This is the left sub-part of the expression. This will be valid, i.e. the contained SISExpression will not have an operator of EOpNone when the operator of this SISExpression is not any of the primitives EPrimTypeString, EPrimTypeOption, EPrimTypeVariable, EPrimTypeNumber, or the functions EFuncExists, EFuncAppProperties.

Right Expression

This is the right sub-part of the expression. This will be valid, i.e. the contained SISExpression will not have an operator of EOpNone when the operator of this SISExpression is any binary operators EBinOpEqual, EBinOpNotEqual, EBinOpGreaterThan, EBinOpLessThan, EBinOpLessOrEqual, EBinOpGreaterOrEqual, or the logical operators ELogOpAnd and ELogOpOr.

Integer Value

This part of the expression can contain an integer value. It will be valid only if the type of the expression is EPrimTypeNumber or EFuncAppProperties

String Value

This part of the expression can contain a string. It will be valid only if the type of the expression is EPrimTypeString, EPrimTypeOption, EPrimTypeVariable or EFuncExists.

As described above, the SISX file is provided as two parts: the SISSignedController part and the SISData part. The above breakdown explains the fields contained in the SISSignedController part. The SISData part will now be explained.

This part of the SISX file contains the actual file data that is used during the install process. It consists of an array of data units, each of which contains the files from one SISController. There may be more than one data unit if there are embedded SISX files. Each SISController has a field containing the index into the Data Units array in the SISData SISField. This field contains the files which are installed by that SISController. This makes it easy to add and remove embedded SISX files. An example of the SISX file format with an embedded SISX file is shown in FIG. 5. The SISData part also contains a number of SISFields as follows.

SISData

The SISData SISField contains all of the file data for a SISX file.

| SISData | Length |
|---|---|
| Data Units | SISArray<SISDataUnit> |

Data Units

There is one data unit present for each SISController in the metadata of the SISX file. There may be more than one SISController, and thus data unit, if there are embedded SISX files.

SISDataUnit

The SISDataUnit SISField contains all the file data for a SISController.

| SISDataUnit | Length |
|---|---|
| File Data | SlSArray<SISCompressed |
| | <SISFileData>> |

File Data

This field is an array of possibly compressed SISFileData SISFields. There is an entry in this array for every file which it is possible for this SISController to install.

SISFileData

The SISFileData SISField contains the actual data for a file.

| SISFileData | Length | |
|---|---|---|
| Data Length | TUint64 | 8 bytes |
| File Data | | Data |
| Length | | |

Data Length

This field contains the length of the compressed data. It is a duplicate of the information present in the SISFileDescription, but is present for convenience.

File Data

This field contains the file data.

In summary, the present invention is considered to provide the following significant advantages of the known software installation packages
Mobile installation is easy to achieve, providing a more convenient installation than via a PC because installation can be carried out virtually anywhere and without wires.
Installation is more efficient and quicker than providing the software on removable media as a standard compressed package because no power, bandwidth or time is wasted in decompressing any files.
Installation is more reliable because it is far less likely that any out-of-memory errors will occur.
Installation is more secure than providing software pre-installed from a standard package on to removable media because it does not bypasses security checks on the provenance and the authenticity of the software.
Installation is more efficient, quicker and more reliable than installation via the wireless internet because it does not rely on a slow and possibly intermittent connection.

Although the present invention has been described with reference to particular embodiments, it will be appreciated that modifications may be effected whilst remaining within the scope of the present invention as defined by the appended claims.

1. A method for installing software on a computing device, the method comprising a decision phase for deciding whether or not to install the software and an installation phase for installing the software, and in which information required by the decision phase comprises metadata having an integrity protected by digital signature and including a respective hash for files to be installed for verifying the integrity of the file data.

2. A method according to claim 1 in which the decision phase includes the verification of the authenticity and integrity of the files to be installed.

3. A method according to claim 1 or 2 wherein the metadata for the decision phase is provided separately from the file data supporting the installation phase.

4. A method according to any one of claims 1 to 3 wherein the decision phase is processed separately from the installation phase.

5. A method according to any one of the preceding claims wherein the digital signature of the metadata and the hashes for the files are verified during file installation or re-verified after file installation, or both.

6. A method according to the preceding claims wherein the metadata comprises information concerning one or more of program dependencies, software module and hardware version support, file locations, author information or vendor information, in addition to the hashes, and where the decision phase makes use of at least a part of this information when deciding whether or not to install the software in addition to the verification of the authenticity and integrity of the files.

7. A method according to any one of the preceding claims wherein the computing device is selected to comprise a mobile telephone or PDA.

8. A method according to the preceding claims wherein the software is provided on removable media which contains the files comprising the software arranged in their correct locations together with the metadata required for the decision phase.

9. A method according to claim 8 wherein the removable media is selected to comprise a Compact Flash card or Multi Media Card or Memory Stick or any other type of writable and removable media.

10. A computing device arranged to operate in accordance with a method as defined in any one of claims 1 to 9.

11. A computer software package for installing software on a computing device for causing the computing device to operate in accordance with a method as defined in any one of claims 1 to 9.

12. A computer software package according to claim 11 comprising part of an operating system for the computing device.
